(19) United States
(12) Patent Application Publication
(10) Pub. No.: US 2015/0065008 A1
(43) Pub. Date: Mar. 5, 2015

(54) NATURE RATTLE

(71) Applicant: Deborah Schein, Shaker Heights, OH (US)

(72) Inventor: Deborah Schein, Shaker Heights, OH (US)

(21) Appl. No.: 14/245,610

(22) Filed: Apr. 4, 2014

Related U.S. Application Data
(60) Provisional application No. 61/812,494, filed on Apr. 16, 2013.

(51) Int. Cl. A63H 5/00; B23P 19/00

(52) U.S. Cl. CPC A63H 5/00; B23P 19/00
USPC 446/419; 29/428

(57) ABSTRACT

A nature rattle (10) comprises a container (20) defining a hollow compartment (21) and items (30) within in this compartment (21) which make a rattling sound when the container (20) is shaken or otherwise moved. The items (30) comprise naturally occurring objects, such as rocks (41) (e.g., minerals, mineraloids, stones, pebbles, crystals, granite, limestone, etc.), plant parts (42) (e.g., nuts, seeds, seed or spore carrying pods, twigs, branches, roots, etc.), and/or animal accouterments (43) (e.g., coral, shells, horns, teeth, etc.). The items (30) can be associated with a particular locale having certain significance to the giver, recipient, or owner of the nature rattle (10).

### RELATED APPLICATION

This application claims priority under 35 USC §119(e) to U.S. Provisional Patent Application No. 61/812494 filed on Apr. 16, 2013. The entire disclosure of this provisional patent application is hereby incorporated by reference.

### BACKGROUND

A rattle toy typically comprises a container defining a hollow compartment and items enclosed within in this compartment. When the container is grasped by a baby, the items move within the compartment to create a rattling sound. Older children, adolescents, and adults also often enjoy rattles for fiddling or other purposes.

### SUMMARY

A rattle is provided wherein the sound-creating items within the compartment comprise naturally occurring objects such as rocks, plant parts, and/or animal accoutrements.

### DRAWINGS

FIGS. 1-4 show an infant, an older child, an adolescent, and an adult, respectfully, holding the nature rattle.

FIG. 5 shows the nature rattle in more detail.

FIG. 6 shows the nature rattle with an informational paper.

FIG. 7 shows the rattle's container part in more detail.

FIGS. 8-12 show other versions of the nature rattle.

FIG. 13 shows the nature rattle with an informational paper.

FIG. 14 shows a station for assembling the nature rattle.

### DESCRIPTION

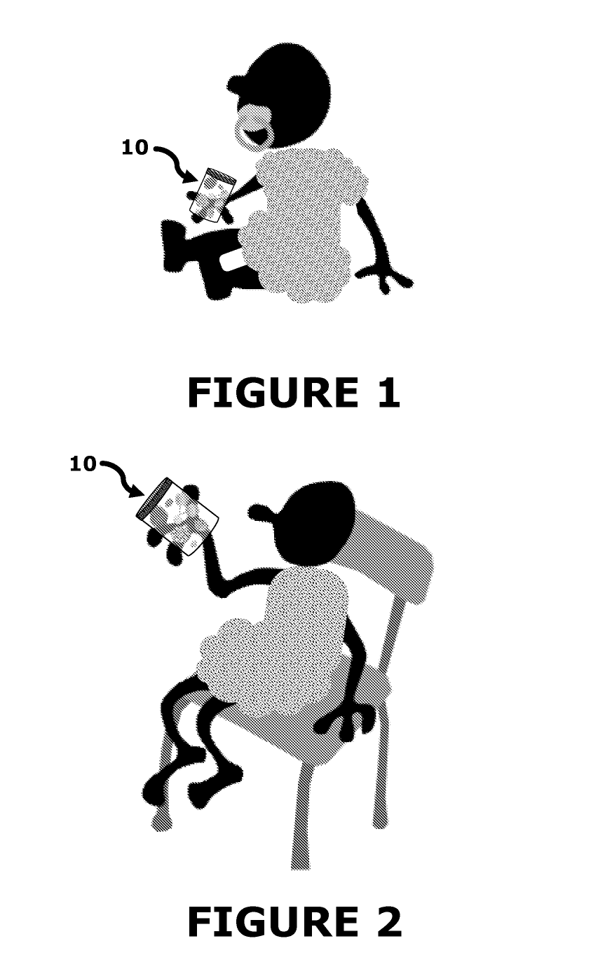

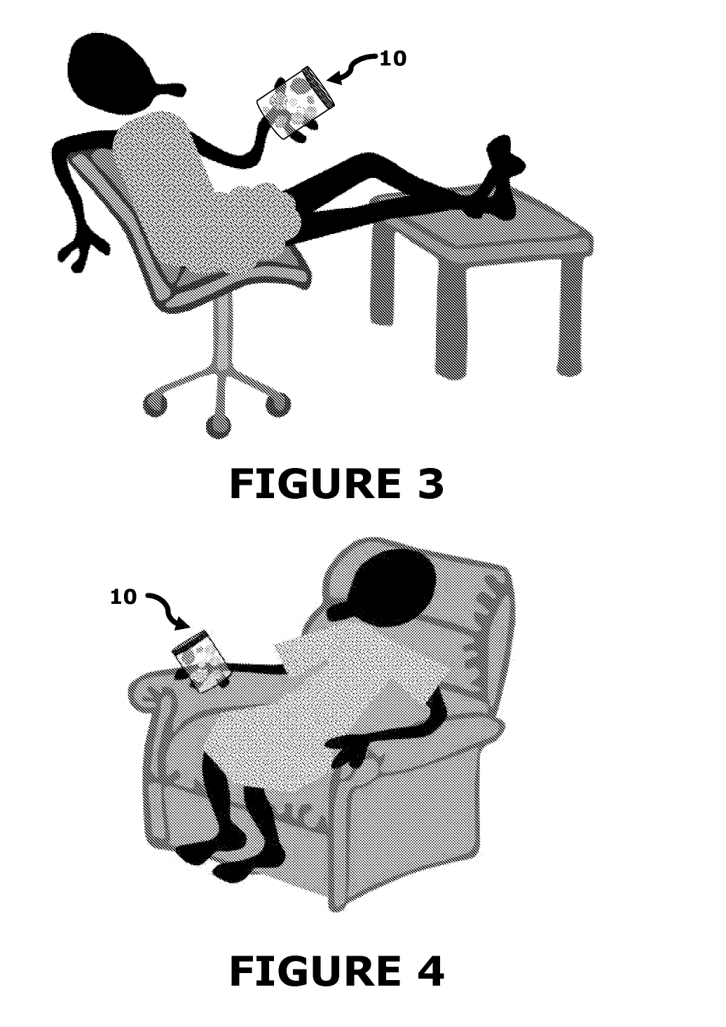

Referring now to the drawings, and initially to FIGS. 1-4, a nature rattle 10 according to the present invention is shown. In FIG. 1, a baby is playing with the nature rattle 10 as he/she would with a conventional rattle toy. In FIG. 2, an older child is enjoying the nature rattle 10. In FIG. 3, an adolescent is appreciating the anti-fidget features of the nature rattle 10 as an anti-fidget device. And, in FIG. 4, an adult is fiddling with the nature rattle 10.

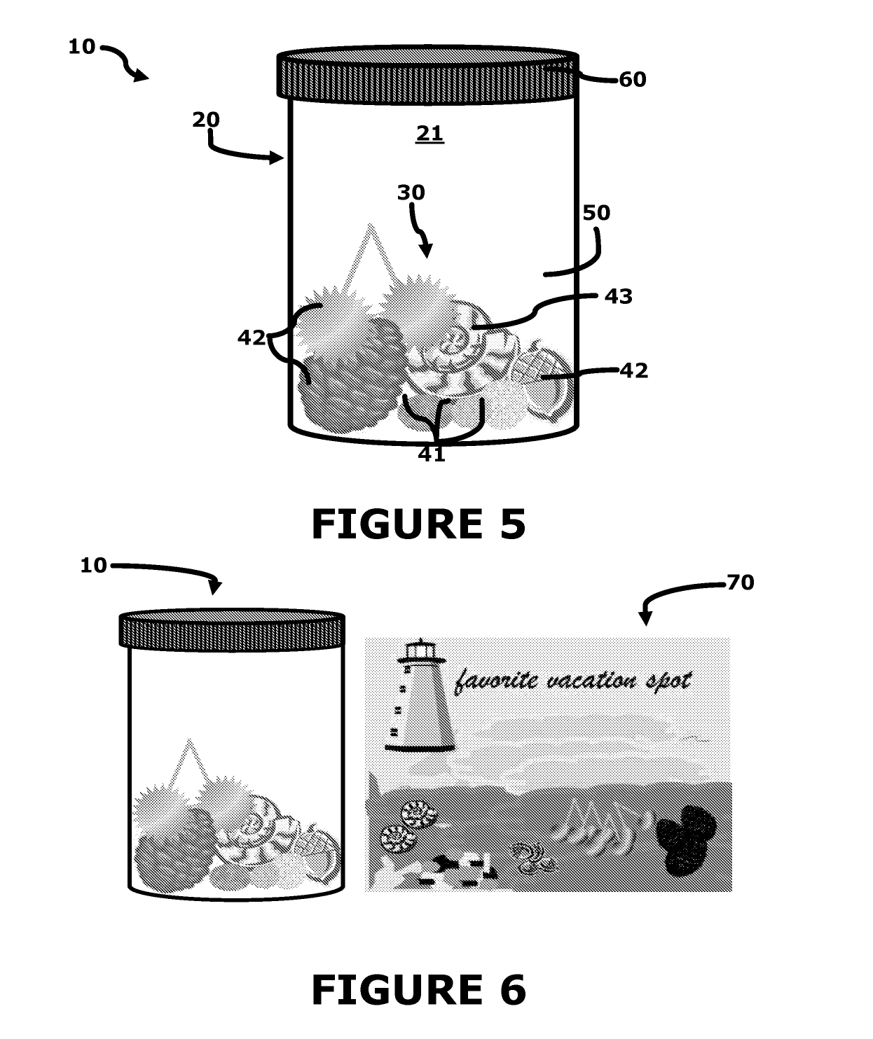

Referring to FIG. 5, the nature rattle 10 comprises a container 20 defining a hollow compartment 21 and items 30 contained therewithin. When the container 20 is shaken or otherwise moved, the items 30 are shifted within the compartment 21 to create a rattling sound. The items 30 include naturally occurring objects such as rocks 41 (e.g., minerals, mineraloids, stones, pebbles, crystals, granite, limestone, etc.), plant parts 42 (e.g., nuts, seeds, seed or spore carrying pods, twigs, branches, roots, etc.), and/or animal accouterments 43 (e.g., coral, shells, horns, teeth, etc.).

The naturally occurring objects 41-43 can be associated with a particular locale (e.g., a favorite vacation spot). And as shown in

FIG. 6, the nature rattle 10 can be provided along with a pamphlet, a postcard, a picture, or other informational paper 70 about this locale.

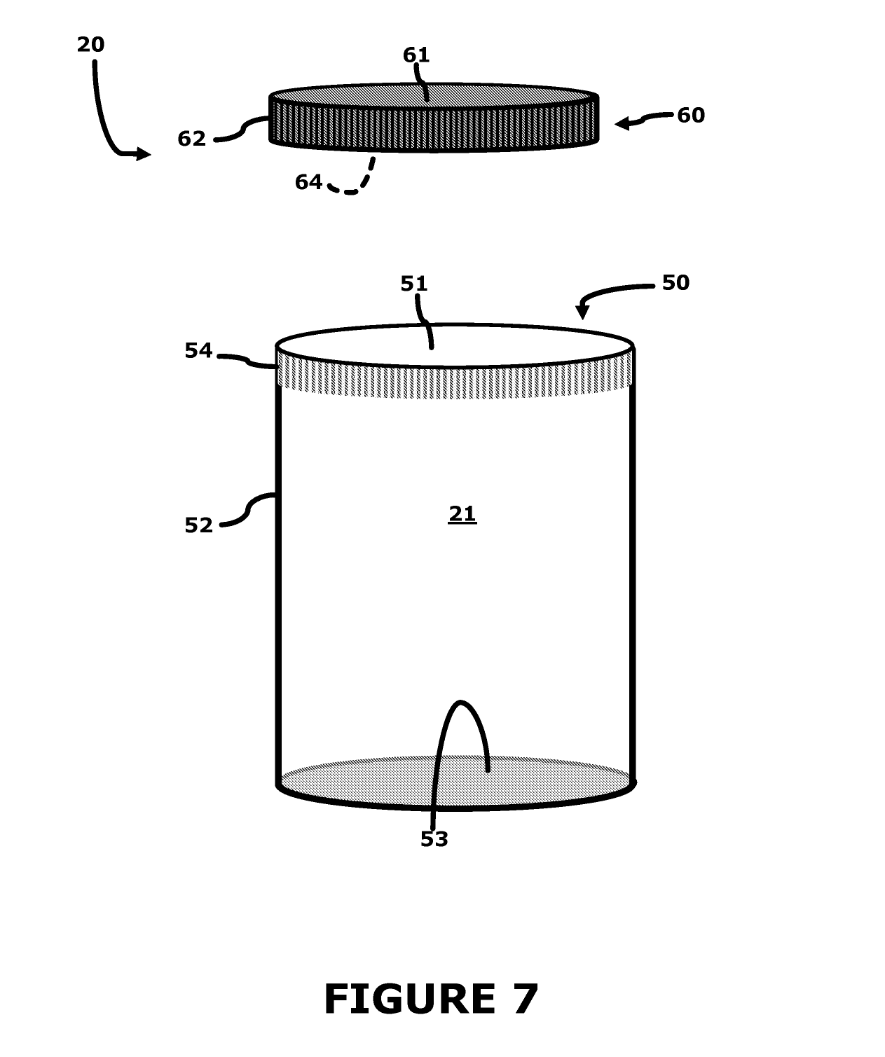

Referring to FIG. 7, the container 20 can comprise a receptacle 50 defining the compartment 21 and having at least one access opening 51 into the compartment 21. When making the nature rattle 10, the access opening 51 can be used for insertion of the items 30 into the compartment 21. The container 20 can further comprise a lid 60 for each access opening 51 which seals the compartment 21 after item insertion.

The illustrated container 20 has a generally cylindrical wall 52 with a diameter sized for gripping by an infant's hand (e.g., about one to about three inches). In the embodiment shown in FIG. 3, the receptacle 50 has one access opening 51 at one axial end of its cylindrical wall 52, with an end wall 53 closing its opposite axial end.

Mating features 54 (e.g., external screw threads) are associated with the access opening 51.

The lid 60 comprises an end wall 61 and a rim 62 extending approximately perpendicular therefrom. Mating features 64 (e.g., internal screw threads) are provided to coordinate with the receptacle's mating features 54 so that the lid 60 may be used to selectively by an adult to open and close the compartment 21.

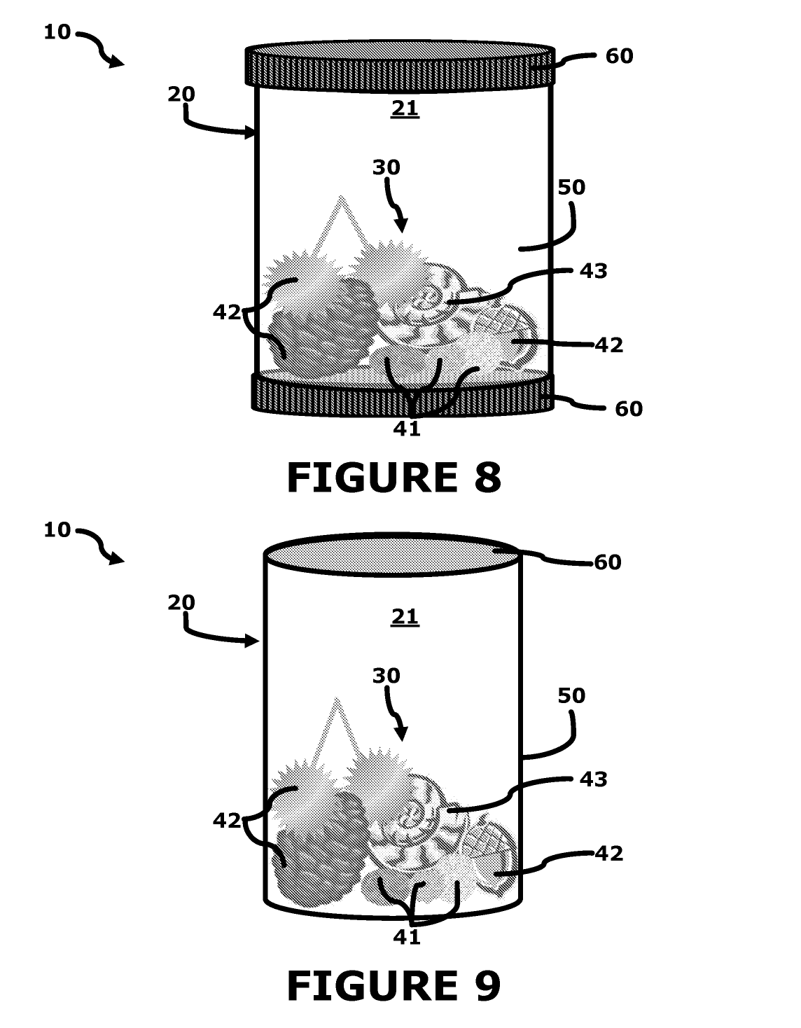

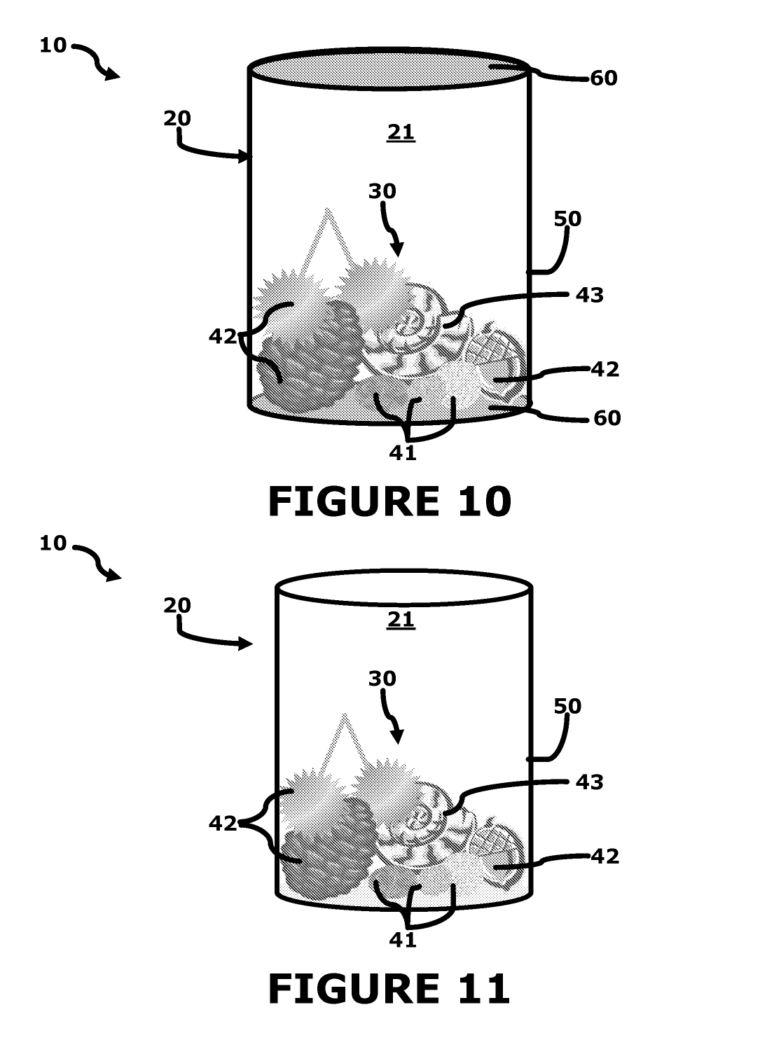

While the container 20 shown in FIG. 7 has one access opening 51 and a removable lid 60, this need not be the case. For example, as shown in FIG. 8, the receptacle 20 can have two access openings 51 (one at each end of a cylindrical wall 52) and a lid 60 for each opening. As shown in FIGS. 9-10, the lids 60 can be permanently secured to the receptacle 50. And as is shown in FIG. 11, if the receptacle 20 is formed around the items 30, an access opening 51 and/or lid 60 may not be necessary to form the container 20.

The container 20 and/or the receptacle 50 can be made of a transparent or translucent material so that the baby can view the items 30 moving within the compartment. A suitable candidate for the receptacle material would be, for example, cellulose acetate butyrate. The lid 60 can be made of a similar plastic material or of another suitable material such as metal. Additionally or alternatively, the receptacle 50 and/or the lid 60 can be recycled products furthering the environmental appeal of the nature rattle 10.

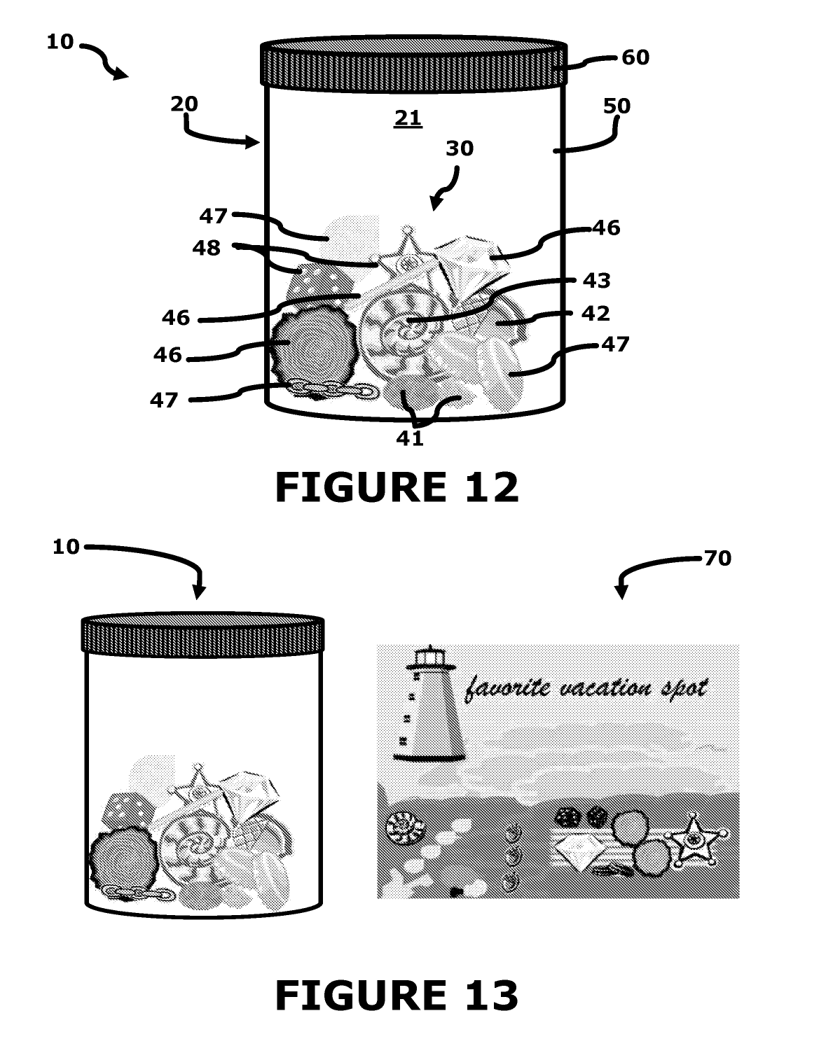

As shown in FIG. 12, the items 30 can additionally comprise processed naturally occurring objects 46 (gemstones, carved wood, braided twine, etc.), nature-influenced manufactured objects 47 (sea glass, weathered metal, worn plastic, etc.), and/or strictly manmade objects 48 (e.g., trinkets, ornaments, knickknacks, etc.).

These objects 46-48 can be associated with a particular locale (e.g., a favorite vacation spot) and, as shown in FIG. 13, a pamphlet, a postcard, a picture, or other informational paper 70 about this locale can be provided with the nature rattle 10.

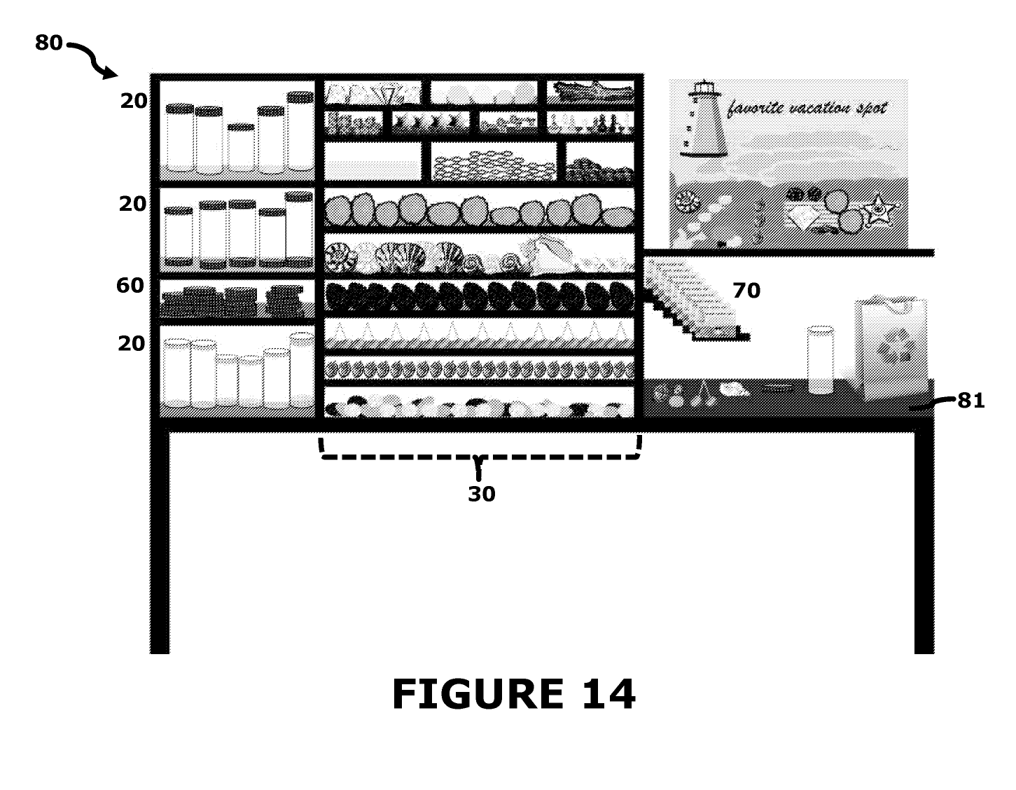

As shown in FIG. 14, an assembly station 80 can be provided for making a customized rattle 10. The station 80 can comprise a platform 81 with shelves or other storage racks for the containers 20 and the items 30. The items 30 can be gathered or associated with the same locate as the residence of the assembly station 80. And pamphlets, postcards, or other informational papers 70 can be provided at the station 80.

Although the nature rattle 10, the container 20, the items 30, the receptacle 50, the lid 60, and/or the assembly station 70 have been shown and described with respect to a certain embodiment or embodiments, it is obvious that equivalent alterations and modifications will occur to others skilled in the art upon the reading and understanding of this specification and the annexed drawings.

1. A nature rattle (10) comprising a container (20) defining a hollow compartment (21) and items (30) within in this compartment (21) which make a rattling sound when the container (20) is moved, wherein the items (30) comprise naturally occurring objects (41-43).

2. A nature rattle (10) as set forth in claim 1, wherein the naturally occurring objects (41-43) comprise rocks (41), plant parts (42), and/or animal accouterments (43).

3. A nature rattle (10) as set forth in claim 1 and a pamphlet, a postcard, a picture, or other informational paper (70) about a certain locale, wherein the naturally occurring objects (41-43) are associated with the same locale.

4. A nature rattle (10) as set forth in claim 1, wherein the items (30) also comprise processed naturally occurring objects (46), nature-influenced manufactured objects (47), and/or strictly manufactured objects (48).

5. A nature rattle (10) as set forth in claim 4 and a pamphlet, postcard, picture, or other informational paper (70) about a certain locale, wherein the naturally occurring objects (41-43), the processed naturally occurring objects (46), the nature-influenced manufactured objects (47), and/or the strictly manufactured objects (48) are associated with the same locale.

6. A nature rattle (10) as set forth in claim 1, wherein the container (20) is at least partially transparent or translucent.

7. A nature rattle (10) as set forth in claim 1, wherein the container (20) comprises receptacle (50) defining the compartment (21) and wherein the receptacle (50) is made of transparent or translucent plastic.

8. A nature rattle (10) as set forth in claim 7, wherein the receptacle (50) has at least one access opening (51) and wherein the container (20) comprises a lid (60) for each access opening (51).

9. A nature rattle (10) as set forth in claim 8, wherein the receptacle (50) has two access openings (51) and wherein the container comprises two lids (60), one for each access opening (51).

10. A nature rattle (10) as set forth in claim 8, wherein the lid (60) is removable by an adult from the receptacle (50).

11. A nature rattle (10) as set forth in claim 8, wherein the receptacle (50) and each lid (60) have mating features (54, 64) which coordinate to allow closing and opening of the compartment (21) via the access opening (51).

12. A nature rattle (10) as set forth in claim 8, wherein the lid (60) is permanently secured to the receptacle (50).

13. A method of making the nature rattle (10) as set forth in claim 8, comprising the steps of inserting the items (30) through the access opening (51) into the compartment (21) and closing the access opening (51) with the lid (60) after item insertion.

14. A rattle-assembly station (80) for assembling the nature rattle (10) set forth in claim 1, said station (80) comprising at least one container (20) and a plurality of items (30) including naturally occurring objects (41-43).

15. A rattle-assembly station (80) as set forth in claim 14, comprising a plurality of containers (20).

16. A rattle-assembly station (80) as set forth in claim 14, wherein the naturally occurring objects (41-43) comprise rocks (41), plant parts (42), and/or animal accouterments (43).

17. A rattle-assembly station (80) as set forth in claim 16, wherein the naturally occurring objects (41-43) are associated with the same locale as the residence of the station.

18. A rattle-assembly station (80) as set forth in claim 16, wherein the items (30) comprise processed naturally occurring objects (46), nature-influenced manufactured objects (47), and/or strictly manufactured objects (48).

19. A rattle-assembly station (80) as set forth in claim 18, wherein the processed naturally occurring objects (46), the nature-influenced manufactured objects (47), and/or the strictly manufactured objects (48) are associated with the same locale as the residence of the station (80).

20. A rattle-assembly station (80) as set forth in claim 17, further comprising pamphlets, postcards, pictures, or other informational papers (70) about the locale.
